(19) United States
(12) Patent Application Publication
(10) Pub. No.: US 2007/0133141 A1
(43) Pub. Date: Jun. 14, 2007

(54) TII decoder and method for detecting TII

(76) Inventors: Joo Hyun Lee, Daejeon (KR); Bon Tae Koo, Daejeon (KR); Nak Woong Eum, Daejon (KR); Hee Bum Jung, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/633,272

(22) Filed: Dec. 4, 2006

(30) Foreign Application Priority Data
Dec. 8, 2005 (KR) 10-2005-0119381
Sep. 11, 2006 (KR) 10-2006-0087451

(51) Int. Cl. H01H 47/00

(52) U.S. Cl. 361/143

(57) ABSTRACT

Provided is a new algorithm for detecting transmitter identification information (TII) in a transceiver system such as terrestrial-digital multimedia broadcasting (TDMB) conforming to the Eureka 147 standard. A TII decoder includes: a magnitude obtainer for monitoring a magnitude of an input signal; a phase obtainer for monitoring a phase of the input signal; a TII pulse determiner for determining whether a TII pulse is input or not, from the magnitude signal and phase signal; and a consistency checker for checking whether delay times of a plurality of TII pulses are identical and whether a TII pattern consisting of the TII pulses is repeated. A method for detecting TII includes the steps of: monitoring a magnitude and phase of an input signal; when the magnitude is higher than a predetermined peak threshold level, determining that the input signal as a peak; comparing phases of two consecutive peaks among the peaks with each other, and when the phases are identical, determining that a TII unit pulse is generated; checking whether delay times of a plurality of TII pulses are identical; checking whether a TII pattern consisting of the TII pulses is repeated a predetermined number of times; and outputting the checked TII pattern. Since the algorithm can be implemented by fully hardwired logic and detect a TII pattern in real time without storing a received symbol, it does not require a memory device and permits considerably smaller hardware size than a conventional digital signal processor (DSP) method.

### CROSS-REFERENCE TO RELATED APPLICATION

This application claims priority to and the benefit of Korean Patent Application Nos. 2005-119381, filed Dec. 8, 2005, and 2006-87451, filed Sep. 11, 2006, the disclosures of which are incorporated herein by reference in their entirety.

### BACKGROUND

1. Field of the Invention

The present invention relates to a transmitter identification information (TII) decoder for recognizing a TII pattern and, particularly, to a decoder for decoding TII in a receiver of a transceiver system using Eureka 147 standard including a terrestrial-digital multimedia broadcasting (TDMB) method and a method for detecting TII.

More specifically, the present invention relates to a decoding algorithm, which stably detects TII using the repetitiveness of a TII signal pattern included in a null section of a transmission frame and the consistency of the repeated patterns and constantly makes a threshold level for distinguishing between noise and a signal pattern to be the optimum level by automatically adjusting the threshold level. The decoding algorithm permits a smaller hardware size as well as stably detects a TII signal in comparison with conventional art and thus can be embodied to consume low power.

2. Discussion of Related Art

A TII signal is transmitted in a null section of a transmission system conforming to Eureka 147 once every two frames. The TII signal is used together with fast information channel (FIC) information to indicate information on a transmitter or repeater transmitting a signal currently received by a receiver.

TII information includes a main identification (ID) (p value in Formula 2 given below) and a sub ID (c value in Formula 2 given below). As illustrated in FIG. 2, the main ID has 70 patterns from 0 to 69, and the sub ID is a delay time and has 24 values from 0 to 23. Here, an actual sub ID value of 0 is reserved for satellite reception. Thus, in the case of TDMB, a combination of the main ID with the sub ID may yield 1610 (=70*23) TII values.

A TII signal is defined by Formula 1 given below, and TII patterns according to mode 1 to mode 4 are defined by Formulas 2 to 5 given below, respectively. A TII pattern in mode 1 is defined by Formulas 1 and 2 and is shown as illustrated in FIG. 1.

$${S}_{TII} ( t ) = Re \{ {ⅇ}^{j 2 π {f}_{C} t} {\sum }_{m = - ∞}^{∞} {\sum }_{k = - K / 2}^{K / 2} {z}_{m , 0 , k} \cdot {g}_{TII , k} ( t - {mT}_{F} ) \} \\ where \\ {g}_{TII , k} ( t ) = {ⅇ}^{j 2 π k ( t - {T}_{NULL} + {T}_{U} ) / {T}_{U}} \cdot Rect ( t / {T}_{NULL} ) \\ {z}_{m , 0 , k} = {A}_{c , p} ( k ) \cdot {ⅇ}^{{jφ}_{k}} + {A}_{c , p} ( k - 1 ) \cdot {ⅇ}^{{jφ}_{k - 1}} \\ {ⅇ}^{{jφ}_{k - 1}} = PRS symbol \qquad Formula 1$$

PRS symbol: phase reference symbol

$${A}_{c , p} ( k ) = \{ \begin{matrix}{\sum }_{b = 0}^{7} δ ( k , - 768 + 2 c + 48 b ) \cdot {a}_{b} ( p ) & for - 768 \leq k < - 384 \\ {\sum }_{b = 0}^{7} δ ( k , - 384 + 2 c + 48 b ) \cdot {a}_{b} ( p ) & for - 384 \leq k < 0 \\ {\sum }_{b = 0}^{7} δ ( k , 1 + 2 c + 48 b ) \cdot {a}_{b} ( p ) & for 0 < k \leq 384 \\ {\sum }_{b = 0}^{7} δ ( k , 384 + 2 c + 48 b ) \cdot {a}_{b} ( p ) & for 384 < k \leq 768\end{matrix} \\ {A}_{c , p} ( 0 ) = {A}_{c , p} ( - 769 ) = 0 \\ 0 \leq c \leq 23 \\ δ ( i , j ) = \{ \begin{matrix}1 if i = j \\ 0 if i \neq j\end{matrix} \\ p \text{:} MainID \\ c \text{:} SubID \qquad Formula 2$$

$${A}_{c , p} ( k ) = {\sum }_{b = 0}^{3} δ ( k , - 192 + 2 c + 48 b ) \cdot {a}_{b} ( p ) + {\sum }_{b = 4}^{7} δ ( k , - 191 + 2 c + 48 b ) \cdot {a}_{b} ( p ) \\ {A}_{c , p} ( 0 ) = {A}_{c , p} ( - 193 ) = 0 \\ 0 \leq c \leq 23 \\ δ ( i , j ) = \{ \begin{matrix}1 if i = j \\ 0 if i \neq j\end{matrix} \qquad Formula 3$$

$${A}_{c , p} ( k ) = {\sum }_{b = 0}^{1} δ ( k , - 96 + 2 c + 48 b ) \cdot {a}_{b} ( p ) + {\sum }_{b = 2}^{3} δ ( k , - 95 + 2 c + 48 b ) \cdot {a}_{b} ( p ) \\ {A}_{c , p} ( 0 ) = {A}_{c , p} ( - 97 ) = 0 \\ 0 \leq c \leq 23 \\ δ ( i , j ) = \{ \begin{matrix}1 if i = j \\ 0 if i \neq j\end{matrix} \qquad Formula 4$$

$${A}_{c , p} ( k ) = \{ \begin{matrix}{\sum }_{b = 0}^{7} δ ( k , - 384 + 2 c + 48 b ) \cdot {a}_{b} ( p ) & for - 384 \leq k < 0 \\ {\sum }_{b = 0}^{7} δ ( k , 1 + 2 c + 48 b ) \cdot {a}_{b} ( p ) & for 0 < k \leq 384\end{matrix} \\ {A}_{c , p} ( 0 ) = {A}_{c , p} ( - 385 ) = 0 \\ 0 \leq c \leq 23 \\ δ ( i , j ) = \{ \begin{matrix}1 if i = j \\ 0 if i \neq j\end{matrix} \qquad Formula 5$$

FIG. 1(A) illustrates 1536 data symbols in transmission mode 1 according to TDMB or Eureka 147 standard after a guard band is removed. In FIG. 1(A), numerals denote frequency indexes of respective symbols. FIG. 1(B) magnifies a quarter of FIG. 1(A). FIG. 1(C) illustrates TII pattern values, which are ideal when P=18 and c=3, i.e., a_{b}(p)=01001110, according to FIG. 1(B).

By a main ID, i.e., p value, a_{b}(p) is determined to be a 8-bit pattern predefined in Eureka 147 standard. The 8-bit pattern of a_{b}(p) determines whether respective bit patterns for 8 blocks having a length of 48 data symbols shown in FIG. 1(B) exist or not. The sub ID, i.e., c value, determines a position of a bit pattern, i.e., an amount of shift, in one block having a size of 48 data symbols as illustrated in FIG. 1(C). The amount of shift is determined to be 2*c, and bit patterns exist always in even and odd pairs according to the formulas considering k in the order from 1 to 768 and from −768 to −1.

A method for decoding TII according to conventional art is described below.

Since a TII signal is carried by a null symbol of every second transmission frame, a method is used in order to first of all determine whether a TII signal is included in a current transmission frame. The method measures power of a transmitted null symbol and when the power is the same as a predetermined threshold level or more, determines that a TII signal is included. Here, in order to measure power, a technique accumulating some null symbols and such is used. In addition, a threshold level should be appropriately set for a receiving environment.

When it is once determined that a TII signal exists, a method is used that transfers data of a null symbol received and demodulated thereafter to a processor, such as a digital signal processor (DSP), then calculates correlation between each of already-known TII patterns and the received data using the transferred data, and so on. When a DSP is not included in a receiver, however, it is hard to use a DSP only for TII detection. Thus, such a method is hard to be applied to a receiver not including a DSP.

### SUMMARY OF THE INVENTION

The present invention is directed to stably detecting transmitter identification information (TII) from a null section of a transmission frame.

The present invention is also directed to automatically adjusting a threshold level of a signal magnitude of a received symbol required for distinguishing between an effective TII signal pattern and noise in a demodulated symbol and thereby constantly maintaining the optimum operation state.

The present invention is also directed to quickly and stably detecting a TII signal pattern from null symbol data.

The present invention is also directed to reducing sensitivity to change of a receiving environment in TII pattern detection.

The present invention is also directed to detecting, with no problem, a TII pattern carried by a null symbol once every two frames without having to recognize which frame transmits the TII pattern.

The present invention is also directed to simplifying a hardware structure required for TII detection.

The present invention is also directed to performing TII detection in real time.

One aspect of the present invention provides a TII decoder comprising: a magnitude obtainer for monitoring a magnitude of an input signal; a phase obtainer for monitoring a phase of the input signal; a TII pulse determiner for determining whether a TII pulse is input or not, from the magnitude and the phase of the input signal; and a consistency checker for checking whether delay times of a plurality of TII pulses are identical and/or whether a TII pattern consisting of the TII pulses is repeated.

Another aspect of the present invention provides a method for detecting TII, comprising the steps of: monitoring a magnitude and phase of an input signal; when the magnitude is higher than a predetermined peak threshold level, determining the magnitude as a peak; comparing phases of two consecutive peaks among the peaks with each other, and when the phases are identical, determining that a TII unit pulse is generated; checking whether delay times of a plurality of TII pulses are identical; checking whether a TII pattern consisting of the TII pulses is repeated a predetermined number of times; and outputting the checked TII pattern.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a time slot diagram illustrating the existence form of a transmitter identification information (TII) signal in mode 1 conforming to the Eureka 147 standard;

FIG. 2 is a table showing TII patterns in mode 1 conforming to the Eureka 147 standard; and

FIG. 3 is a block diagram illustrating the configuration and connection structure of a TII decoder according to an exemplary embodiment of the present invention.

### DETAILED DESCRIPTION OF EXEMPLARY EMBODIMENTS

Hereinafter, exemplary embodiments of the present invention will be described in detail. However, the present invention is not limited to the embodiments disclosed below, but can be implemented in various forms. Therefore, the following embodiments are described in order for this disclosure to be complete and enabling to those of ordinary skill in the art.

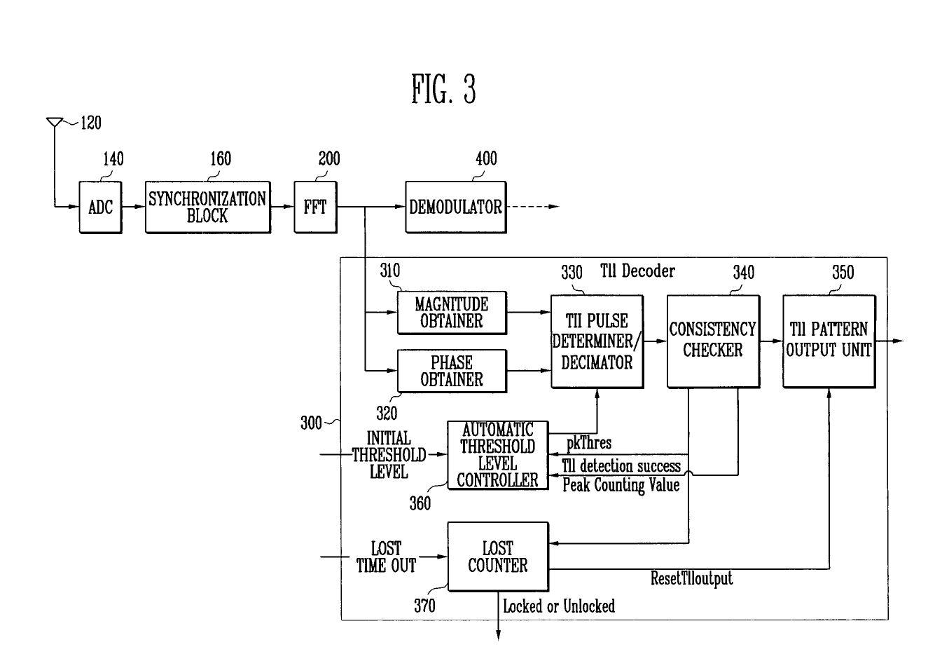

The configuration of a transmitter identification information (TII) decoder according to an exemplary embodiment of the present invention is shown in a block diagram of FIG. 3. An illustrated TII decoder 300 comprises a magnitude obtainer 310, a phase obtainer 320, a TII pulse determiner 330, and a consistency checker 340. The magnitude obtainer 310 monitors a magnitude of an input signal output from a fast Fourier transformer (FFT) 200. The phase obtainer 320 monitors a phase of the input signal. The TII pulse determiner 330 considers an input signal higher than a predetermined threshold level as a peak, and when peaks having the same phase are repeated twice, determines that the signal is a TII pulse. The consistency checker 340 checks whether delay times of a plurality of TII pulses are identical and/or whether a TII pattern consisting of the TII pulses is repeated.

For more improved functions, the TII decoder 300 of FIG. 3 may further comprise an automatic threshold-level controller 360, a TII pattern output unit 350 or a lost counter 370. The automatic threshold-level controller 360 gives the threshold level, increases the threshold level when a counted number of the TII pulses is smaller than a reference number, and decreases the threshold level when the counted number of the TII pulses is greater than the reference number. The TII pattern output unit 350 buffers the TII pattern output from the consistency checker 340 and when TII pattern detection fails, maintains a previous buffer value. The lost counter 370 counts the number of times that TII pattern detection fails.

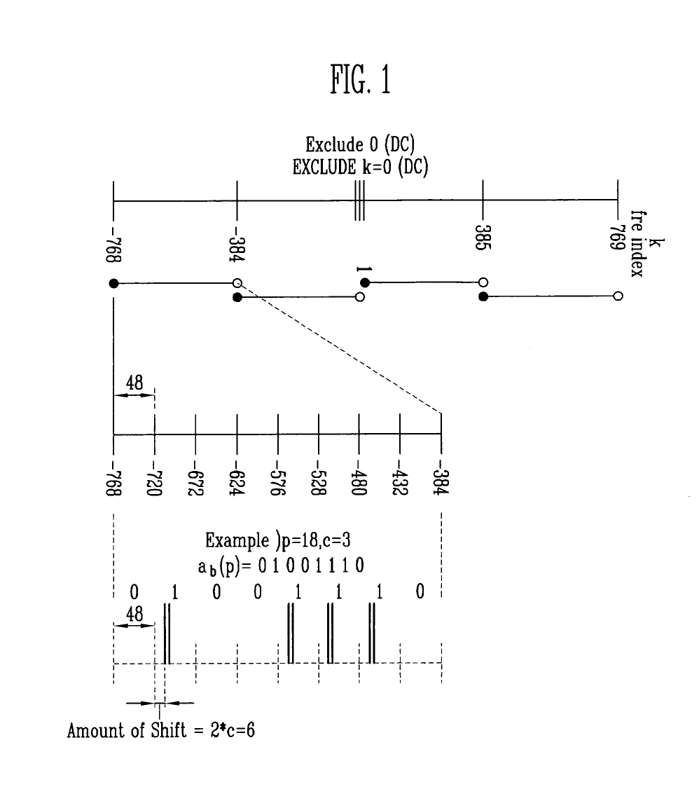

Operation of each block constituting the illustrated TII decoder will be described below. First, the magnitude obtainer 310 and the phase obtainer 320 are described. According to Formulas 1 and 2 given above, each TII pattern always appears as a pair, as illustrated in FIG. 1. When a TII pattern value exists when k=i, it must exist even when k=i+1. Here, the two consecutive symbols have the same phase, which means values of a real number part and imaginary number part have the same sign. According to such a characteristic, using simple magnitude calculation and phase information, it is possible to recognize where a TII pattern exists in a received null symbol. In other words, the magnitude obtainer and the phase obtainer extract magnitude information and phase information from the input signal. However, in order to ensure a stable TII receiving ratio, it is necessary to increase the reliability of decoded TII by several times of detection. In this embodiment, the reliability of detected value is increased by checking consistency of TII patterns.

Next, the TII pulse determiner 330 is described. The illustrated TII pulse determiner 330 is implemented by a peak detector/decimator. The peak detector/decimator obtains phase sign information of the same two consecutive values using the information extracted by the magnitude obtainer 310 and the phase obtainer 320. When the two consecutive values both are higher than a peak threshold level pkThres, the peak detector/decimator considers them as a peak value, recognizes the highest value of such peaks in a 48 time slot symbol data block as a peak value of a TII pattern, and outputs a position signal corresponding to the peak value. Here, the decimator block performs decimation to convert two input data into one position signal and outputs the decimated signal to the consistency checker 340.

Next, the consistency checker 340 and a consistency check process performed by the consistency checker 340 are described. According to Formulas 1 and 2, in FIG. 1(A), the pattern of FIG. 1(B) is repeated four times. In other words, an 8-bit pattern of a_{b}(p) is repeated four times, and the repeated patterns should have the same value. In addition, when a TII pattern exists in each 48 time slot symbol data block of FIG. 1(B), all the blocks have the same amount of shift, i.e., the same sub-identification (ID) (c value). Thus, in the entire section of FIG. 1(A), c value is repeated 16 (=32/2) times and the repeated values should be identical.

The peak detector/decimator block determines whether a TII pattern exists in 48 time slot symbol data blocks of FIG. 1(C). With respect to a block in which the TII pattern exists, the consistency checker 340 records a position of the TII pattern in the 48 time slot symbol data block as a c value, checks consistency between the c value and a previous c value, and records an a_{b}(p) bit pattern as ‘1’. In addition, with respect to a block in which no TII pattern exists, the consistency checker 340 records an ab(p) bit pattern as ‘0’. By the above-described process, it is possible to check whether delay times of a plurality of TII pulses are identical (first consistency check). In addition, when the previous operation is completed for eight 48 symbol data blocks, the consistency checker 340 compares the recorded 8-bit pattern of the a_{b}(p) with a 8-bit pattern of a previous a_{b}(p) to check consistency. Thus, it is possible to check whether a TII pattern consisting of the TII pulses is repeated as many times as a number according to the standard (second consistency check).

By continuously checking whether the c value and the a_{b}(p) pattern are uniformly maintained in entire section (A) of FIG. 1 in this manner, it is possible to increase the reliability of the c value and the a_{b}(p) pattern value, so that TII can be stably decoded. For accurate TII decoding, it is preferable to perform both the first consistency check and second consistency check. However, for the purpose of excessively simplifying the structure, the consistency checker 340 may be implemented to perform only one of the two consistency checks. Meanwhile, the consistency checker 340 may have an 8 bit register for the second consistency check.

Next, the automatic threshold-level controller 360 is described. For clear understanding, operation of the automatic threshold-level controller 360 is described with reference to FIGS. 1 and 3.

The automatic threshold-level controller 360 is a block outputting the peak threshold level pkThres used for the peak detector/decimator block 330 to determine an effective peak. The automatic threshold-level controller 360 outputs a predetermined initial threshold level as the peak threshold level pkThres in an early stage of driving. After the initial state, the automatic threshold-level controller 360 automatically adjusts the peak threshold level pkThres to the optimum value using a peak counting value and TII detection success signal.

When a TII pattern is successfully demodulated, the TII detection success signal is enabled, and the peak counting value must be 16 in mode 1. This means that 16 peaks must be generated when the detection is normally succeeded.

On the contrary, when a TII pattern is not normally detected, the peak counting value is greater or smaller than 16. When the peak counting value is smaller than 16, some peaks of an actual TII pattern are less than the peak threshold level pkThres and thus not detected. Thus, it is determined that the peak threshold level pkThres is set to be a little high, and the peak threshold level pkThres is reduced. When the peak counting value is greater than 16, peak values of noise as well as the actual TII pattern is higher than the peak threshold level pkThres, and noise is detected as a peak. Thus, it is determined that the peak threshold level pkThres is set to be a little low, and the peak threshold level pkThres is increased.

By setting an increase value and decrease value of the peak threshold level pkThres to be different from each other, it is possible to adjust the detection method between minute detection and quick detection. When the increase value is set to be greater than the decrease value, it takes more time to succeed in TII detection again after one failure in TII detection. However, the increase value greater than the decrease value is preferable because the tendency of change in the peak threshold level pkThres can be estimated, adjustment decreasing the peak threshold level pkThres is minutely made, a little high default peak threshold level pkThres is advantageous for stability, and so on. As described above, the TII detection apparatus according to this embodiment can constantly and automatically maintain/adjust the optimum peak threshold level pkThres without external adjustment.

Next, operation of the lost counter 370 is described. When a TII pattern is not successfully demodulated, the illustrated lost counter 370 records the number of failures in TII pattern detection. When the number of failures becomes greater than a set lost time out value, the lost counter 370 outputs an unlock signal Unlocked and changes a TII pattern output to a value indicating a predetermined undetected state.

A TII pattern is carried by a null symbol and received at a receiving terminal and its data is not protected in comparison with general data symbols, and thus its receiving ratio is poor. However, the TII pattern is not frequently changed in consideration of TII characteristics. Therefore, when the TII pattern is not received for a short predetermined period (preliminary period), it may be advantageous to assume that continuous communication with a current transmitter is possible. The lost counter 370 is aimed to measure the preliminary period, thereby improving the robustness of the TII pattern.

Lastly, the illustrated TII pattern output unit 350 is described. When a TII pattern is successfully detected, a TII pattern value is immediately changed to a new value. When TII pattern detection fails, a previous TII pattern value is maintained until a reset signal is received from the lost counter 370. When the reset signal is generated from the lost counter 370, the previous TII pattern value is changed to a value indicating the undetected state. The value indicating the undetected state is a value other than the main ID and the sub ID determined by the standard.

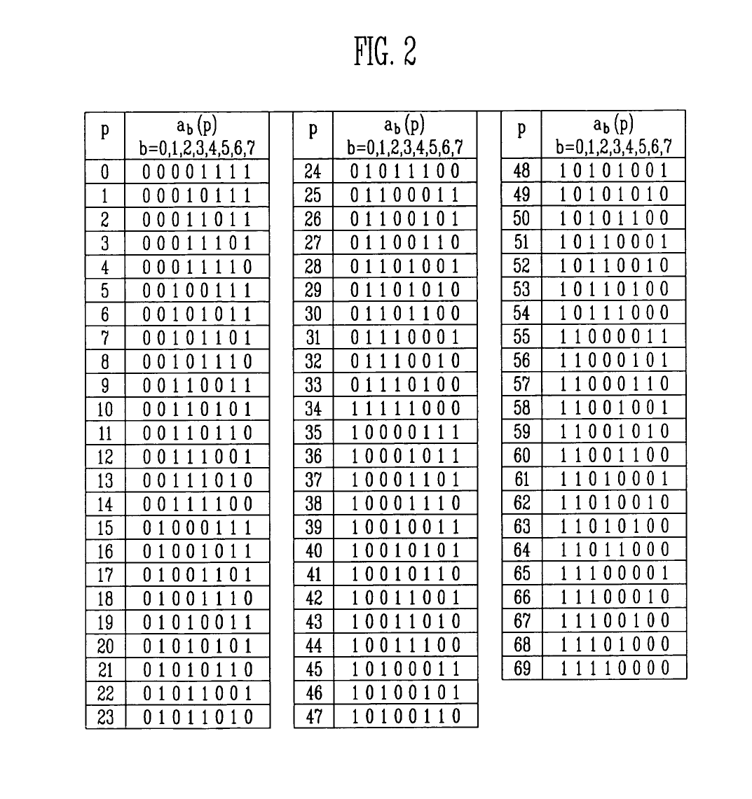

By the combination of the lost counter 370 and the TII pattern output unit 350, it is possible to quickly detect the TII pattern and also improve the robustness of the detected TII pattern. Meanwhile, since the present invention performs an on-the-fly process using not a memory device but symbol data output one by one from the FFT block 200, the sequence of detected a_{b}(p) patterns may be different from the sequence of a_{b}(p) patterns of FIG. 2. The TII pattern output unit 350 also serves to rearrange such a sequence.

A method for detecting TII performed by the TII decoder 300 according to this embodiment comprises the steps of: (a) monitoring a magnitude and phase of an input signal; (b) when the magnitude is higher than a predetermined peak threshold level, determining that the magnitude is a peak; (c) comparing phases of two consecutive peaks among the peaks with each other, and when the phases are identical, determining that a TII unit pulse is generated; (d) checking whether delay times of a plurality of TII pulses are identical; (e) checking whether a TII pattern consisting of the TII pulses is repeated a predetermined number of times; and (f) outputting the checked TII pattern.

Referring to FIG. 3, step (a) is performed by the magnitude obtainer 310 and the phase obtainer 320, steps (b) and (c) are performed by the TII pulse determiner 330, and steps (d) and (f) are performed by the consistency checker 340.

The TII detection method is performed on 1536 data symbols of TDMB or Eureka 147 standard. The method may further comprise the steps of decreasing the peak threshold level when the number of data symbols determined as peaks among the 1536 data symbols is less than 16, and increasing the peak threshold level when the number of data symbols determined as peaks is more than 16. The additional steps are performed by the automatic threshold-level controller 360 of FIG. 3.

In step (e), when there are data symbols determined as peaks in a 48 time slot symbol data block among the 1536 data symbols, the bit pattern is recognized as ‘1’. On the contrary, when there is no data symbol determined as a peak, the bit pattern is recognized as ‘0’. In this manner, the TII pattern is checked in step (e).

Although mode 1 has been described in connection with Formula 1, Formula 2 and FIG. 1, the present invention can be likewise applied to transmission mode 2, mode 3 and mode 4 conforming to the Eureka 147 standard. The lengths of the transmission frame and the null symbol in mode 4 are only a half of the lengths in mode 1, the lengths in mode 2 are only a third of the lengths in mode 1, and the lengths in mode 3 are only a quarter of the lengths in mode 1. This may cause a difference in the length of FIG. 1(A), i.e., the length of the null symbol, and the number of times that the TII pattern is repeated, but the basic concept of the algorithm of the present invention can be equally applied to the modes. Thus, descriptions of mode 2, mode 3 and mode 4 will be omitted because they can be derived from the description of mode 1.

The TII decoder of the present invention can stably detect TII information using the repetitiveness of TII signal patterns included in a null section of a transmission frame and the consistency of the repeated patterns.

In addition, the TII decoder of the present invention automatically adjusts a threshold level of a signal magnitude of a received symbol required for distinguishing between an effective TII signal pattern and noise in a demodulated symbol, thereby constantly maintaining the optimum value.

In addition, the TII decoder of the present invention can quickly and stably detect a TII signal pattern from one null symbol data.

In addition, the TII decoder of the present invention maintains a previous TII pattern value for a predetermined time despite failure in detecting a TII signal, thereby reducing sensitivity to change of a receiving environment in TII pattern detection.

In addition, the present invention ensures smooth detection of a TII pattern carried by a null symbol once every two frames without having to recognize which frame transmits the TII pattern.

In addition, the algorithm of the present invention can improve a processing speed because it can be mostly implemented by hardware logic, can detect a TII pattern in real time without having to store a received symbol, and can permit a much smaller hardware size than a conventional digital signal processor (DSP) method without demanding a memory device.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A transmitter identification information (TII) decoder, comprising:
a magnitude obtainer for monitoring a magnitude of an input signal;
a phase obtainer for monitoring a phase of the input signal;
a TII pulse determiner for determining whether a TII pulse is input or not, from the magnitude and the phase of the input signal; and
a consistency checker for checking at least one of whether delay times of a plurality of TII pulses are identical and whether a TII pattern consisting of the TII pulses is repeated.

2. The TII decoder of claim 1, wherein the TII pulse determiner determines an input signal higher than a predetermined threshold level as a peak, and when peaks having the same phase are repeated twice, determines the repeated peaks as a TII pulse.

3. The TII decoder of claim 2, wherein the consistency checker counts the number of times that a TII pulse is generated in a predetermined time section.

4. The TII decoder of claim 3, further comprising an automatic threshold-level controller for giving the threshold level, increasing the threshold level when the counted number of TII pulses is smaller than a reference number, and decreasing the threshold level when the counted number of TII pulses is greater than the reference number.

5. The TII decoder of claim 1, further comprising a TII pattern output unit for buffering a TII pattern output from the consistency checker, and when TII pattern detection fails, maintaining a previous buffer value.

6. The TII decoder of claim 1, further comprising a lost counter for counting the number of times that TII pattern detection fails.

7. A method for detecting TII, comprising the steps of:
(a) monitoring a magnitude and phase of an input signal;
(b) when the magnitude of the input signal is higher than a predetermined peak threshold level, determining the input signal as a peak;
(c) comparing phases of two consecutive peaks among the peaks with each other, and when the phases are identical, determining that a TII unit pulse is generated;
(d) checking whether delay times of a plurality of TII pulses are identical;
(e) checking whether a TII pattern consisting of the TII pulses is repeated a predetermined number of times; and
(f) outputting the checked TII pattern.

8. The method of claim 7, wherein steps (a) to (f) are performed on 1536 data symbols of terrestrial-digital multimedia broadcasting (TDMB) or Eureka 147 standard.

9. The method of claim 8, further comprising the steps of:
when the number of data symbols determined as peaks among the 1536 data symbols is less than 16, decreasing the peak threshold level; and
when the number of data symbols determined as peaks among the 1536 data symbols is more than 16, increasing the peak threshold level.

10. The method of claim 8, wherein in step (e), when there is a symbol determined as a peak in a 48 time slot symbol data block among the 1536 data symbols, a bit pattern is recognized as ‘1’, and when there is no symbol determined as a peak, a bit pattern is recognized as ‘0’.
